(19) United States
(12) Patent Application Publication
(10) Pub. No.: US 2012/0050059 A1
(43) Pub. Date: Mar. 1, 2012

(54) METHOD FOR DEVICE LOSS PREVENTION

(75) Inventor: Christopher P. Klicpera, Westbury, NY (US)

(73) Assignee: Symbol Technologies, Inc., Schaumburg, IL (US)

(21) Appl. No.: 12/870,874

(22) Filed: Aug. 30, 2010

(51) Int. Cl. G08B 21/00; G06K 7/01; G06K 7/14

(52) U.S. Cl. 340/686.6; 235/462.45; 235/472.01

(57) ABSTRACT

A method and apparatus of preventing a handheld data capture device from getting lost. The handheld data capture device includes a barcode reading arrangement or an RFID reader. The handheld data capture device also includes a cue-generating element that is operative to generate a perception cue if (1) the handheld data capture device is removed from the host and (2) the handheld data capture device is separated from the hand of a user for a time period that is longer than a predetermined time interval. The perception cue can be in the form of light flashing, audio beeps, or mechanical vibrations.

### FIELD OF THE DISCLOSURE

The present disclosure relates generally to handheld data capture devices including handheld barcode readers or handheld RFID readers.

### BACKGROUND

Various electro-optical systems have been developed for reading optical indicia, such as barcodes. A barcode is a coded pattern of graphical indicia comprised of a series of bars and spaces of varying widths. In a barcode, the bars and spaces having differing light reflecting characteristics. Some of the barcodes have a one-dimensional structure in which bars and spaces are spaced apart in one direction to form a row of patterns. Examples of one-dimensional barcodes include Uniform Product Code (UPC), which is typically used in retail store sales. Some of the barcodes have a two-dimensional structure in which multiple rows of bar and space patterns are vertically stacked to form a single barcode. Examples of two-dimensional barcodes include Code 49 and PDF417, which are respectively described in U.S. Pat. No. 4,794,239 and U.S. Pat. No. 5,304,786.

Systems that use one or more solid-state imagers for reading and decoding barcodes are typically referred to as imaging-based barcode readers, imaging scanners, or imaging readers. A solid-state imager generally includes a plurality of photosensitive elements or pixels aligned in one or more arrays. Examples of solid-state imagers include charged coupled devices (CCD) or complementary metal oxide semiconductor (CMOS) imaging chips.

FIG. 1A shows an imaging scanner 50 in accordance with some implementations. The imaging scanner 50 has a window 56 and a housing 58 with a handle. The imaging scanner 50 also has a base 52 for supporting itself on a countertop. The imaging scanner 50 can be used in a hands-free mode as a stationary workstation when it is placed on the countertop. The imaging scanner 50 can also be used in a handheld mode when it is picked up off the countertop and held in an operator's hand. In the hands-free mode, products can be slid, swiped past, or presented to the window 56. In the handheld mode, the imaging scanner 50 can be moved towards a barcode on a product, and a trigger 54 can be manually depressed to initiate imaging of the barcode. In some implementations, the base 52 can be omitted, and the housing 58 can also be in other shapes.

In FIG. 1A, a cable 59 is also connected to the base 52. The cable 59 can be implemented to provide the power to the imaging scanner 50. In other implementations, as shown in FIG. 1B, the imaging scanner 50 can be detachably placed in a cradle 100. When the imaging scanner 50 detachably settled in the cradle 100, the imaging scanner 50 can be charged with a cable 59 connected to the cradle 100. When the imaging scanner 50 is removed from the cradle 100, it functions as a cordless handheld device that can freely move around. In addition, the imaging scanner 50 generally can communicate with the cradle 100 through certain wireless connections.

While a cordless handheld device offers the convenience and utility that it can be freely carried around, such a cordless handheld device can get lost more easily than a tethered device. In an exemplary scenario in which the cordless imaging scanner 50 is used for healthcare applications in a hospital environment, this cordless scanner can become lost in bed sheets and thrown out with the laundry. There are also other scenarios in which cordless handheld devices can be easily stolen or get lost. In some existing implementations, some of the hosts can monitor the radio contact between the hosts from the cordless device, and if the cordless device goes out of radio contact with the host, the user can be alerted. But radio range varies widely with environment, and can't be relied on for a definitive distance. By the time the device draws attention to itself it may already be lost or stolen. Also, this method conflicts with the usual desire for the greatest radio range possible. Therefore, it may be desirable to find a better method for preventing a handheld data capture device from getting lost.

### SUMMARY

In one aspect, the invention is directed to a method of preventing a handheld data capture device from getting lost. The handheld data capture device includes a barcode reading arrangement or an RFID reader. The method includes (1) determining if the handheld data capture device is removed from a host and (2) determining if the handheld data capture device is separated from the hand of a user for a time period that is longer than a predetermined time interval. The method also includes generating a perception cue if (1) the handheld data capture device is removed from the host and (2) the handheld data capture device is separated from the hand of the user for a time period that is longer than the predetermined time interval.

In another aspect, the invention is directed to an apparatus. The apparatus includes a host configured to accommodate detachably a handheld data capture device. The handheld data capture device includes a barcode reading arrangement or an RFID reader. The handheld data capture device also includes a cue-generating element that is operative to generate a perception cue if (1) the handheld data capture device is removed from the host and (2) the handheld data capture device is separated from the hand of a user for a time period that is longer than a predetermined time interval. The perception cue can be in the form of light flashing, audio beeps, or mechanical vibrations.

Implementations of the invention can include one or more of the following advantages. The disclosed method and apparatus can prevent a handheld data capture device from getting lost by alerting the user as soon as there is some practical possibility that the device can get lost. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A shows an imaging scanner in accordance with some embodiments.

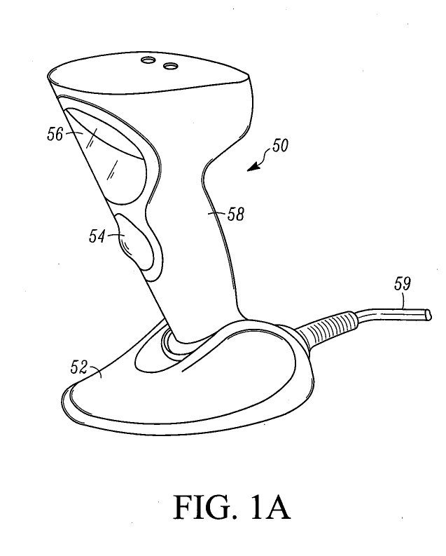

FIG. 1B shows an imaging scanner that is detachably placed in a cradle in accordance with some embodiments.

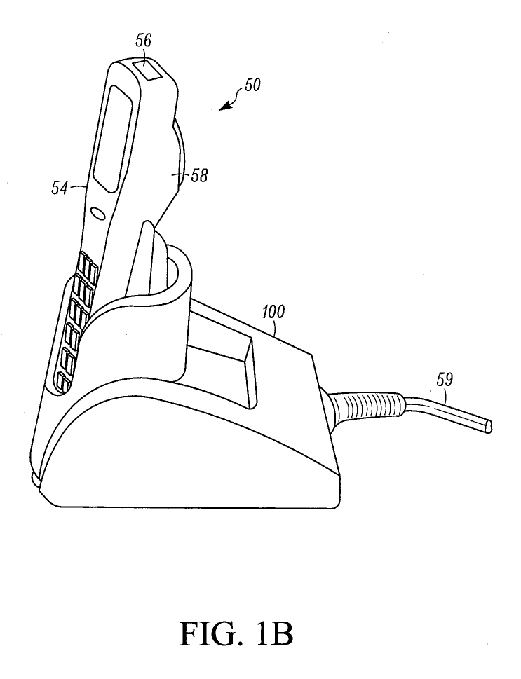

FIG. 2 is a schematic of an imaging scanner in accordance with some embodiments.

FIG. 3 shows a handheld data capture device and a cradle associated with a stationary workstation in accordance with some embodiments.

FIG. 4 is a flowchart of a method of preventing a handheld data capture device from getting lost in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

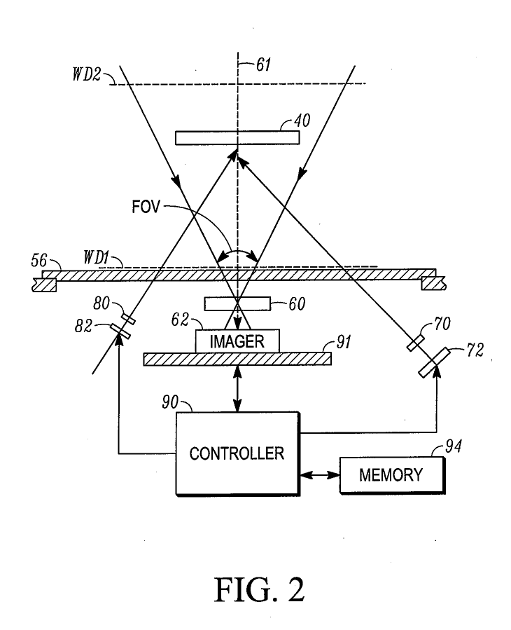

FIG. 2 is a schematic of an imaging scanner 50 in accordance with some embodiments. The imaging scanner 50 in FIG. 2 includes the following components: (1) a solid-state imager 62 positioned behind an imaging lens assembly 60; (2) an illuminating lens assembly 70 positioned in front of an illumination source 72; (3) an aiming lens assembly 80 positioned in front of an aiming light source 82; and (4) a controller 90. In FIG. 2, the imaging lens assembly 60, the illuminating lens assembly 70, and the aiming lens assembly 80 are positioned behind the window 56. The solid-state imager 62 is mounted on a printed circuit board 91 in the imaging scanner.

The solid-state imager 62 can be a CCD or a CMOS imaging device. The solid-state imager 62 generally includes multiple pixel elements. These multiple pixel elements can be formed by a one-dimensional array of photosensitive elements arranged linearly in a single row. These multiple pixel elements can also be formed by a two-dimensional array of photosensitive elements arranged in mutually orthogonal rows and columns. The solid-state imager 62 is operative to detect light captured by an imaging lens assembly 60 along an optical path or axis 61 through the window 56. Generally, the solid-state imager 62 and the imaging lens assembly 60 are designed to operate together for capturing light scattered or reflected from a barcode 40 as pixel data over a two-dimensional field of view (FOV).

The barcode 40 generally can be located anywhere in a working range of distances between a close-in working distance (WD1) and a far-out working distance (WD2). In one specific implementation, WD1 is about a few inches from the window 56, and WD2 is about a few feet from the window 56. Some of the imaging scanners can include a range finding system for measuring the distance between the barcode 40 and the imaging lens assembly 60. Some of the imaging scanners can include an auto-focus system to enable a barcode be more clearly imaged with the solid-state imager 62 based on the measured distance of this barcode. In some implementations of the auto-focus system, the focus length of the imaging lens assembly 60 is adjusted based on the measured distance of the barcode. In some other implementations of the auto-focus system, the distance between the imaging lens assembly 60 and the solid-state imager 62 is adjusted based on the measured distance of the barcode.

In FIG. 2, the illuminating lens assembly 70 and the illumination source 72 are designed to operate together for generating an illuminating light towards the barcode 40 during an illumination time period. The illumination source 72 can include one or more light emitting diodes (LED). The illumination source 72 can also include a laser or other kind of light sources. The aiming lens assembly 80 and the aiming light source 82 are designed to operate together for generating a visible aiming light pattern towards the barcode 40. Such aiming pattern can be used by the operator to accurately aim the imaging scanner at the barcode. The aiming light source 82 can include one or more light emitting diodes (LED). The aiming light source 82 can also include a laser or other kind of light sources.

In FIG. 2, the controller 90, such as a microprocessor, is operatively connected to the solid-state imager 62, the illumination source 72, and the aiming light source 82 for controlling the operation of these components. The controller 90 can also be used to control other devices in the imaging scanner. The imaging scanner 50 includes a memory 94 that can be accessible by the controller 90 for storing and retrieving data. In many embodiments, the controller 90 also includes a decoder for decoding one or more barcodes that are within the field of view (FOV) of the imaging scanner 50. In some implementations, the barcode 40 can be decoded by digitally processing a captured image of the barcode with a microprocessor.

In operation, in accordance with some embodiments, the controller 90 sends a command signal to energize the illumination source 72 for a predetermined illumination time period. The controller 90 then exposes the solid-state imager 62 to capture an image of the barcode 40. The captured image of the barcode 40 is transferred to the controller 90 as pixel data. Such pixel data is digitally processed by the decoder in the controller 90 to decode the barcode. The information obtained from decoding the barcode 40 is then stored in the memory 94 or sent to other devices for further processing.

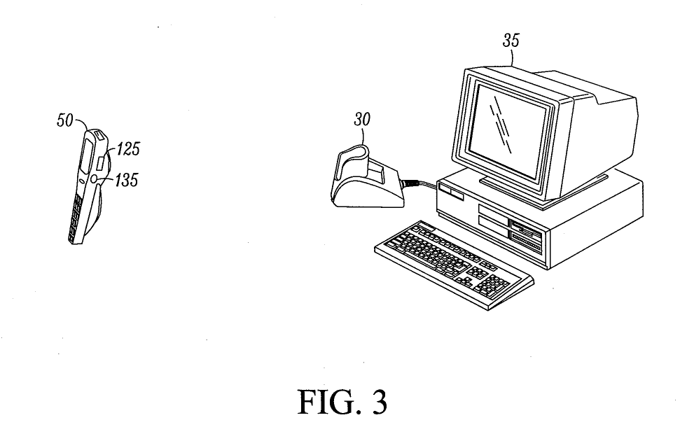

FIG. 3 shows a handheld data capture device 50 and a cradle 30 associated with a stationary workstation 35 in accordance with some embodiments. In FIG. 3, the cradle 30 is configured to accommodate a handheld data capture device 50 such that it can be detachably settled in. The handheld data capture device 50 can include a barcode reading arrangement or an RFID reader. In the implementation as shown in FIG. 3, a first sensing device is placed either on the cradle 30 or on the handheld data capture device 50 for determining if the handheld data capture device is removed from the cradle. The handheld data capture device 50 includes a second sensing device 125 for determining if the handheld data capture device is separated from the hand of a user.

In some implementations, the second sensing device 125 can be a capacitive sensor implemented as a dead-man-switch that is only activated when the user is holding the handheld data capture device. When the handheld data capture device is separated from the hand of a user, the dead-man-switch is deactivated and triggers an event that can be sent to a controller. In other implementations, the second sensing device 125 on the handheld data capture device can be a mechanical switch, motion detector, capacitive or infrared proximity sensor, or an RFID detector. When an RFID detector is used as the second sensing device 125, an RFID chip can be placed on a glove to make it possible to detect a separation between the handheld data capture device and the hand of a user wearing the glove.

In FIG. 3, the handheld data capture device 50 also includes a cue-generating element 135, such as, a light generator, an audio generator, or a vibration generator. The cue-generating element 135 on the handheld data capture device 50 is operative to generate a perception cue if (1) the handheld data capture device 50 is removed from the cradle 30 and (2) the handheld data capture device is separated from the hand of a user for a time period that is longer than a predetermined time interval. The perception cue can be in the form of light flashing, audio beeps, mechanical vibrations, or any combination of the three. In some implementations, the predetermined time interval can be essentially zero. In other implementations, the predetermined time interval can be less than one second. In still other implementations, the predetermined time interval can be between one second and ten seconds. The predetermined time interval can also be longer than ten seconds.

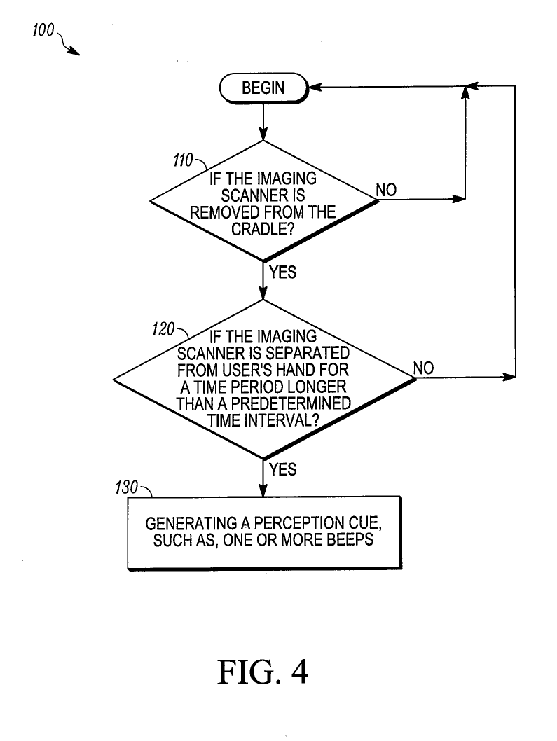

FIG. 4 is a flowchart of a method 100 of preventing a handheld data capture device from getting lost in accordance with some embodiments. The handheld data capture device can include a barcode reading arrangement or an RFID reader. The method 100 includes blocks 110, 120, and 130. At block 110, it needs to be determined if the handheld data capture device is removed from a host. At block 120, it needs to be determined if the handheld data capture device is separated from the hand of a user for a time period that is longer than a predetermined time interval. At block 130, a perception cue (e.g., audio beeps) is generated if (1) the handheld data capture device is removed from the host and (2) the handheld data capture device is separated from the hand of the user for a time period that is longer than the predetermined time interval. With the method 100, generating the perception cue can include any combination of flashing a light source, generating one or more beeps, or causing the handheld data capture device to vibrate.

In practicing the method 100 of FIG. 4, the host can be a cradle configured to accommodate the handheld data capture device detachably settled therein. The host can also be a side-wall or a countertop of a stationary workstation. In the flowchart of FIG. 4, a controller first determines if the handheld data capture device is removed from a host before it determines if the handheld data capture device is separated from the hand of a user. Alternatively, a controller can first determine if the handheld data capture device is separated from the hand of a user before it determines if the handheld data capture device is removed from a host.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of preventing a handheld data capture device from getting lost, the method comprising:
determining if the handheld data capture device is removed from a host, wherein the handheld data capture device includes at least one of a barcode reading arrangement and an RFID reader;
determining if the handheld data capture device is separated from the hand of a user for a time period that is longer than a predetermined time interval; and
generating a perception cue if (1) the handheld data capture device is removed from the host and (2) the handheld data capture device is separated from the hand of the user for a time period that is longer than the predetermined time interval.

2. The method of claim 1, wherein the generating comprises:
flashing a light source.

3. The method of claim 1, wherein the generating comprises:
generating one or more beeps.

4. The method of claim 1, wherein the generating comprises:
causing the handheld data capture device to vibrate.

5. The method of claim 1, wherein the generating comprises:
sending a radio communication signal to the host to cause the host to generate the perception cue.

6. The method of claim 1, wherein the predetermined time interval is essentially zero.

7. The method of claim 1, wherein the predetermined time interval is less than one second.

8. The method of claim 1, wherein the predetermined time interval is between one second and ten seconds.

9. The method of claim 1, wherein the host is a cradle.

10. An apparatus comprising:
a cradle configured to accommodate a handheld data capture device detachably settled therein, the handheld data capture device including at least one of a barcode reading arrangement and an RFID reader;
a first sensing device for determining if the handheld data capture device is removed from the cradle;
a second sensing device on the handheld data capture device for determining if the handheld data capture device is separated from the hand of a user;
a cue-generating element on the handheld data capture device; and
wherein the cue-generating element on the handheld data capture device is operative to generate a perception cue if (1) the handheld data capture device is removed from the cradle and (2) the handheld data capture device is separated from the hand of the user for a time period that is longer than a predetermined time interval.

11. An apparatus comprising:
a host configured to accommodate detachably a handheld data capture device, the handheld data capture device including at least one of a barcode reading arrangement and an RFID reader;
a cue-generating element on the handheld data capture device; and
wherein the cue-generating element on the handheld data capture device is operative to generate a perception cue if (1) the handheld data capture device is removed from the host and (2) the handheld data capture device is separated from the hand of a user for a time period that is longer than a predetermined time interval.

12. The apparatus of claim 11, wherein the cue-generating element includes a light generator.

13. The apparatus of claim 11, wherein the cue-generating element includes an audio generator.

14. The apparatus of claim 11, wherein the cue-generating element includes a vibration generator.

15. The apparatus of claim 11, wherein the host comprises a sensing device to detect whether the handheld data capture device is removed from the host.

16. The apparatus of claim 11, wherein the handheld data capture device comprises a sensing device to detect whether the handheld data capture device is removed from the host.

17. The apparatus of claim 11, wherein the handheld data capture device comprises a sensing device to detect whether the handheld data capture device is separated from the hand of the user.

18. The apparatus of claim 17, wherein the sensing device on the handheld data capture device includes a capacitive sensor dead-man-switch that is only activated when the user is holding the handheld data capture device.

19. The apparatus of claim 17, wherein the sensing device on the handheld data capture device includes one of a mechanical switch, a motion detector, a capacitive or infrared proximity sensor, and an RFID detector.

20. The apparatus of claim 11, wherein the predetermined time interval is essentially zero.

21. The apparatus of claim 11, wherein the predetermined time interval is less than one second.

22. The apparatus of claim 11, wherein the predetermined time interval is between one second and ten seconds.

23. The apparatus of claim 11, wherein the host is a cradle configured to accommodate the handheld data capture device detachably settled therein.

24. The apparatus of claim 11, wherein the host is a side-wall of stationary workstation.

25. The apparatus of claim 11, wherein the host is a countertop of a stationary workstation.
